(19) United States
(12) Patent Application Publication
(10) Pub. No.: US 2016/0063057 A1
(43) Pub. Date: Mar. 3, 2016

(54) MAINTAINING BACKGROUND KNOWLEDGE IN COMPLEX EVENT PROCESSING

(71) Applicant: AGT International GmbH, Zurich (CH)

(72) Inventor: Holger ZIEKOW, Frankfurt (DE)

(21) Appl. No.: 14/835,753

(22) Filed: Aug. 26, 2015

Related U.S. Application Data
(60) Provisional application No. 62/041,797, filed on Aug. 26, 2014.

(51) Int. Cl. G06F 17/30; G06F 11/30

(52) U.S. Cl. CPC G06F 17/30442; G06F 11/3065; G06F 17/30292

(57) ABSTRACT

A system and method for maintaining and updating a complex event processing system in response to real-world changes, to avoid non-optimal queries that can lead to poor performance and/or erroneous results. The knowledge model of the complex event processing system is monitored to identify elements that impact query optimization and additional knowledge elements that would impact query optimization if they were present. A watch model is constructed for the identified elements, and responses to monitor queries sent to the event processor are checked to determine if the system requires re-optimization. When monitor query responses indicate that the system requires re-optimization, the affected queries are re-optimized and redeployed automatically.

### CROSS REFERENCE TO RELATED APPLICATIONS

This application claims the benefit of U.S. Provisional Application No. 62/041,797 filed on Aug. 26, 2014 which is hereby incorporated by reference in their entirety.

### BACKGROUND

Complex event processing (CEP) involves tracking and analyzing multiple information streams related to events, where different streams may involve combining data from a variety of sources. As a consequence, enormous amounts of data may typically be gathered and stream in, thereby burdening the system with the need for continuous processing of high data volumes. Considerable work has been done to improve processing efficiency for large data streams, such as by modeling the background knowledge about the application environment or target application (e.g. typical traffic volumes at certain streets in traffic monitoring applications), and using the knowledge model to develop rule sets for query transformation to optimize queries for efficiency.

Although tangible benefits have accrued from background model-based improvements, a number of disadvantages have also surfaced:

When underlying assumptions in the knowledge model no longer apply due to real-world changes, the optimized queries are liable to yield faulty results.

Changes in the knowledge model are typically detected only after a delay, during which time the fallout from the faulty queries propagates.

Even if the query results are not faulty, the performance of optimized queries is liable to degrade as the knowledge model becomes less applicable to the new realities. In particular, the outdated optimized queries are liable to run with sub-optimal resource utilization.

Currently, the only solution to the problem of keeping query transformations up-to-date in the face of real-world changes is to rebuild and retrain the background model. There are currently no metrics for determining whether this would be beneficial, however, with the consequence that there is no clear basis for deciding when reviewing and restructuring the background model would be justified.

It would therefore be highly advantageous to have a method and system for efficiently monitoring real-world changes and updating the background knowledge model and optimized queries of a complex event processing system in real-time accordingly, so that queries continually remain optimal. This goal is met by embodiments of the present invention.

### SUMMARY

Embodiments of the present invention provide methods and systems for continuously and efficiently maintaining a background knowledge model for complex event processing in response to real-world changes, which avoids the non-optimal conditions described above. A scheme according to an embodiment ties in into optimization that uses background knowledge of the target domain (herein denoted as a “knowledge model”) for optimizing the execution of complex event processing queries. In certain embodiments, the knowledge model incorporates specific types of elements, such as temporal relations and order relations. A related embodiment uses as input both the knowledge model and information about the performed optimization in the form a set of knowledge elements that have had an impact on the optimization. This set can be determined as the optimization rules are executed, and then needs to be translated in monitoring queries that observe a change. Another embodiment provides an arrangement of hardware and embedded software/firmware components to enhance and extend current optimization capabilities.

Further embodiments of the invention provide continuous queries that monitor relevant parts of the knowledge model that impact query optimization, by creating a model herein referred to as a “watch model”, by analyzing the current set of optimized queries to identify existing elements of the knowledge model that affect optimization. According to certain embodiments, an optimized query is analyzed against a related original query for identifying subsets of the knowledge model that affect query optimization. In one related embodiment, an optimization analyzer is included in the query optimizer. In another related embodiment, the watch model is determined by the query optimizer. In yet another related embodiment, additional elements are identified that would affect query optimization if they were present in the knowledge model. When relevant changes in the knowledge model are detected, the system is evaluated to determine if re-optimization of the running queries is needed, and if so, re-optimization is initiated.

By identifying relevant subsets of the knowledge model and monitoring the knowledge model in real-time, embodiments of the present invention yield the following benefits:
avoiding erroneous results that would occur in some optimizations as the assumptions for the optimizations change over time;
avoiding performance degradation of optimized queries as assumptions for the optimizations change over time; and
reducing resource utilization for maintaining the knowledge model by determining bounded subsets of the knowledge that impact optimization.

Therefore, according to an embodiment of the present invention, there is provided maintenance system for updating an event processing system in response to real-world changes, wherein the complex event processing system includes an event processor, a query optimizer, and a knowledge model for which there exists at least one original query and at least one optimized query related thereto, the maintenance system including: (a) a data processing system, including: (b) an optimization analyzer, for analyzing the at least one optimized query against the at least one original query, and identifying a subset of the knowledge model that affects query optimization; (c) a watch model stored in a non-transitory data storage unit of the data processing system, wherein the watch model includes the subset of the knowledge model that affects query optimization; (d) a monitor query generator, for generating a monitor query based on the subset of the knowledge model that affects query optimization, and for sending the monitor query to the event processor; and (e) a knowledge change listener, for receiving a monitor query response from the event processor in response to the monitor query, for updating the knowledge model according to the monitor query response, and, if re-optimization is required, for sending an initiate optimization command to the query optimizer.

In addition, according to another embodiment of the present invention, there is provided a method for updating an event processing system in response to real-world changes, wherein the complex event processing system includes an event processor, a query optimizer, and a knowledge model for which there exists at least one optimized query, the method including: (a) identifying a subset of the knowledge model that affects query optimization; (b) generating a monitor query to keep track of the identified subset of the knowledge model; (c) sending the monitor query to the event processor; (d) updating the knowledge model according to a query response from the event processor; and (e) re-optimizing an affected optimized query in accordance with the updated knowledge model.

Moreover, according to a further embodiment of the present invention, there is provided a maintenance product for updating an event processing system in response to real-world changes, wherein the complex event processing system includes an event processor, a query optimizer, and a knowledge model for which there exists at least one optimized query, the maintenance product including executable code stored in a machine-readable non-transitory data storage, such that when the executable code is executed by a data processing device, the executable code causes the data processing device to perform: (a) identifying a subset of the knowledge model that affects query optimization; (b) generating a monitor query to keep track of the identified subset of the knowledge model; (c) sending the monitor query to the event processor; (d) updating the knowledge model according to a query response from the event processor; and (e) re-optimizing an affected optimized query in accordance with the updated knowledge model.

### BRIEF DESCRIPTION OF THE DRAWINGS

The subject matter disclosed may best be understood by reference to the following detailed description when read with the accompanying drawings in which:

FIG. 1 is a conceptual block diagram of a typical complex event processing system with optimization.

FIG. 2 is a conceptual block diagram of a complex event processing system with optimization, and having a maintenance system for efficient update of background knowledge and optimized queries according to an embodiment of the present invention.

FIG. 3 illustrates a transformation of an original query into a transformed query according to a Markov knowledge model.

FIG. 4 illustrates a portion of the Markov model of FIG. 3 that is relevant to a watch model in FIG. 2, according to an embodiment of the present invention.

FIG. 5 is a flowchart of an automated method for updating a knowledge model and optimized queries according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

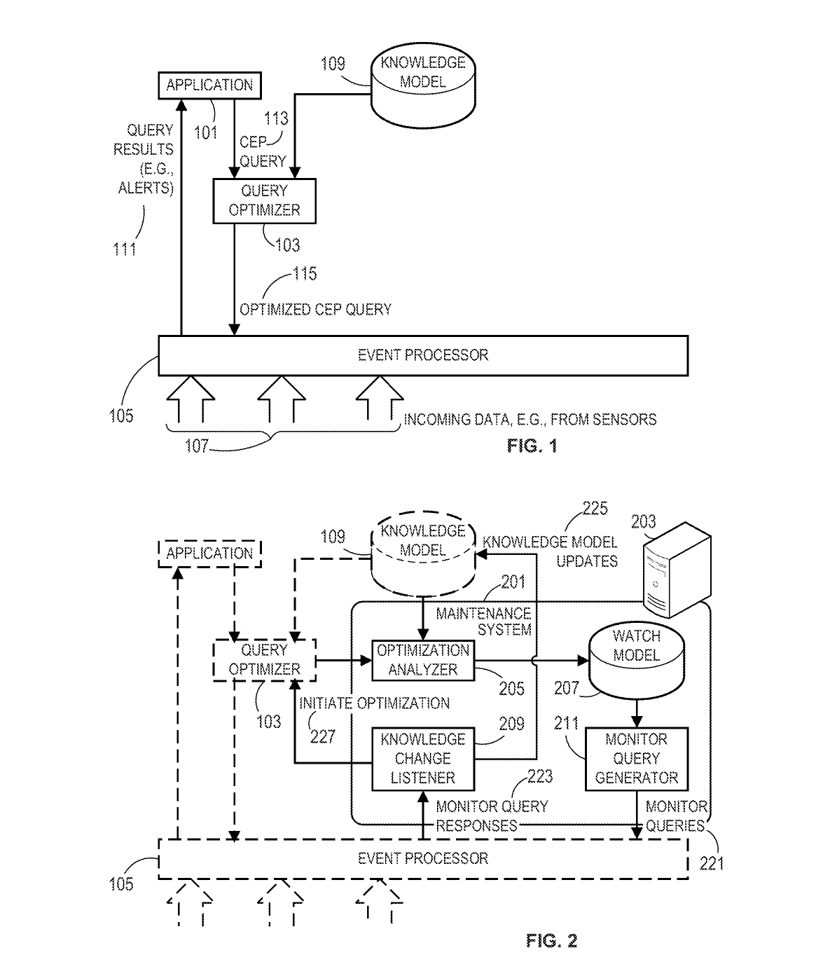

FIG. 1 is a conceptual block diagram of a typical complex event processing system with optimization. An application 101 sends a continuous query 113 to a query optimizer 103 which receives input from a knowledge model 109. Query optimizer 103 performs a transformation on CEP query 113 to output an optimized CEP query 115, which is sent to an event processor 105, which receives incoming data 107 from a variety of sources. Event processor 105 then sends query results 111 to application 101.

FIG. 2 is a conceptual block diagram of the complex event processing system with optimization of FIG. 1, and having a maintenance system 201 for efficient maintenance of background knowledge and optimized queries according to an embodiment of the present invention. Maintenance system 201 contains a data processor 203 (such as a system including a server and/or other associated apparatus with embedded software and/or firmware and non-transitory data storage devices), an optimization analyzer 205 a watch model 207, a knowledge change listener 209, and a monitor query generator 211, which are implemented by components of hardware and/or software and/or firmware components, modules, and non-transitory data storage units associated with maintenance system 201 and data processor 203.

As detailed below, optimization analyzer 205 analyzes the optimizations from query optimizer 103 according to knowledge model 109, and uses the results to build watch model 207, which contains a subset of knowledge model 109 that is identified by optimization analyzer 205 as affecting query optimization. Based on watch model 207, monitor query generator 211 creates monitor queries 221, which are input to event processor 105. Event processor 105 then outputs monitor query responses 223 to knowledge change listener 209, which sends knowledge model updates 225 and, if re-optimization is required, knowledge change listener 209 then sends an initiate optimization command 227 to query optimizer 103.

### Using Markov Knowledge Models

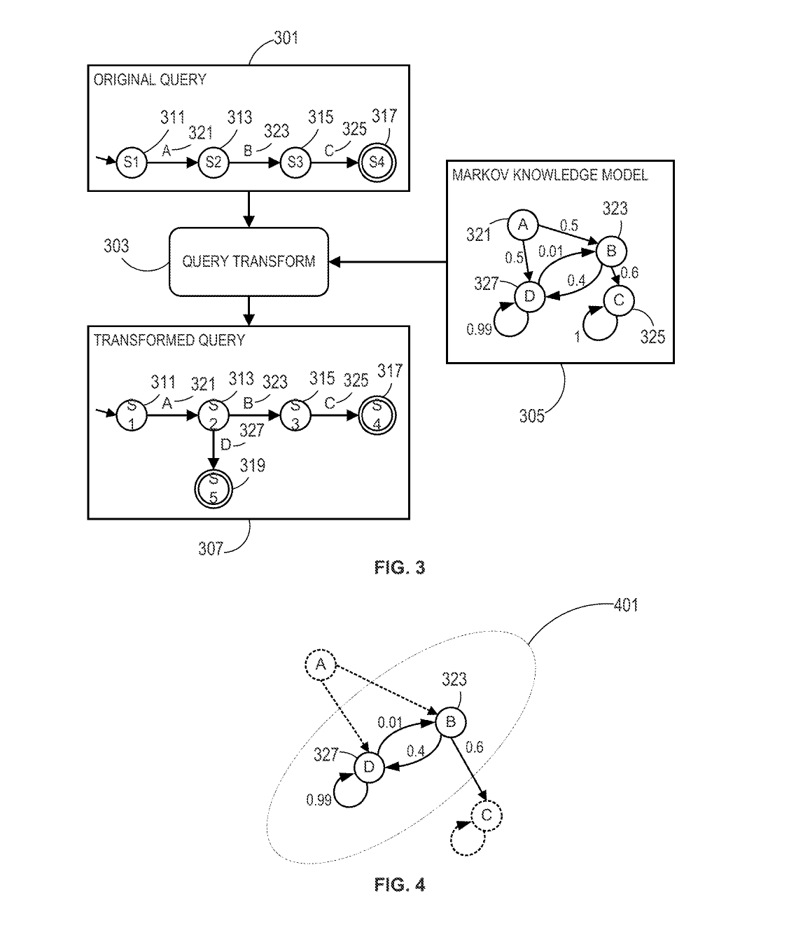

FIG. 3 illustrates a non-limiting example of a transformation of an original query 301 into a transformed query 307 according to a Markov knowledge model 305, via a query transform 303. Query 301 is a sequence query during a time window T for sequences of an event A 321, an event B 323, and an event C 325 as a pattern over a state machine having a state S1 311, a state S2 313, a state S3 315, and a state S4 317. A non-limiting example of such a query would be for observing vehicles that pass checkpoints A, B, and C during time T. Markov knowledge model 305 is a directed graph illustrating the probabilities of various event sequences, also including an event D 327 (e.g., the probability of event sequence B→D occurring is 0.4, whereas the probability of event sequence B→C occurring is 0.6).

Query transform 303 recognizes event D 327 and a corresponding state S5 319. These are present in transformed query 307, with a low path probability for D→C. This actually makes the initial query inaccurate, but more resource-efficient. This is a tradeoff that could be favorable in certain applications.

FIG. 4 illustrates a portion 401 of Markov knowledge model 305 that is relevant to watch model 207 (FIG. 2), according to an embodiment of the present invention.

Below is a simplified demotion of the corresponding monitor queries in CEP pseudo-language:

Query 1:
Select count (B→D)/(count (B→D)+count (B→C)), count (B→C)/(count (B→D)+count (B→C)) from B, C

Query 2:
Select count (D→D)/(count (D→D)+count (D→B)), count (D→B)/(count (D→D)+count (D→B)) from D, B
   Optimized Sequence Extraction with Behavioral Profiles as Background Knowledge

In another non-limiting example, a watch model is derived for a case in which behavioral profiles from log files are used to develop a knowledge model that is at least partly based on the behavioral profiles. Developing a knowledge model in such a fashion is known, as is optimizing the queries thereof, but the example presented below illustrates novel aspects of the present invention in maintaining the knowledge model and updating the queries accordingly.

Behavioral profiles capture relations between events relating to an observed entity. This knowledge is used to transform queries in order to optimally tailor them to the observed setting. For instance, new elements can be introduced in the query, indicating that the original query will never match in a given instance, allowing the query to be aborted early. Using behavioral profiles is well-suited to business processes but is equally applicable in other domains that could be modeled with the expressiveness of a business process model, such as observing and tracking vehicles in a road network, as exemplified below in CEP pseudo-language:

Original Query:
Select A.picture, A.model, A.color, A.speed, B.speed from (A→B (where A.licensePlate==B.licensePlate)) [within 1 h]

Knowledge Model:
Profile 1: B,C,mutual exclusive [1 h]
It is noted that including the time element is an extension to the original behavior profiles which have no notion of time.
(this denotes that events B, C cannot occur within 1 hour for the same vehicle)
Profile 2: F, G, strict order [10 m]
(this denotes that events F, G cannot occur in reverse order within 10 minutes for the same vehicle 1)
Profile 3: F,G,mutual exclusive [1 h]
(this denotes that events F, G cannot occur within 1 hour for the same vehicle)

Optimized Query:
Select A.picture, A.model, A.color, A.speed, B.speed from (A→(B && NOT C)) (where A.licensePlate==B.licensePlate and A.licensePlate==C.licensePlate) [within 1 h]

According to the embodiment of the present invention for this example:

Watch Model:

1 Profile 1: B,C,mutual exclusive [1 h]

and

Monitor Query:
select “B,C,not mutual exclusive” from (B && C) (where B.licensePlate==C.licensePlate)
[within 1 h]
   Optimized Semantic CEP Queries with Linked Entitites as Background Knowledge

A further non-limiting example illustrates another embodiment of the present invention that relates to semantic support in CEP queries using a knowledge base to resolve semantic operators. The knowledge base includes information about the relationships between people, and, in this example, a query detects if a building is sequentially observed by several mutually-acquainted suspects. A simplified version of such a query in CEP pseudo-language is:

Original Query:
watchesBuilding (A)→watchesBuilding (B)
where (A knows B) [within 2 days]

Knowledge Base:
The knowledge base includes facts about suspects and their relationships, as well as rules that describe what constitutes an assumption that two people know each other:
Fact 1: Joe knows Dean
Fact 2: Joe knows Bill
Fact 3: . . .
Rule 1:

```
count (
    A seen_at X and B seen_at X
    [within 1 min]
  ) > 5
  → A knows B
```

Rule 2: . . .

Optimized Query:
Query optimization for semantic CEP queries can materialize background knowledge from the knowledge base in the query, for this example as follows:

Watch Model:
For building the watch model, it is inferred that the relation “knows” from the knowledge base is used, and that Rule 1 (above) impacts the knowledge about “knows”. The watch model therefore includes Rule 1.
watchesBuilding (Joe)→watchesBuilding(B) where (B==Dean OR B==Bill) [within 2 days]

Knowledge Monitor Query:
Rule 1 is in the watch model, so the following monitor query is created:

```
Select count
  (
    A in seen_at (X) &&
    B in seen_at (X)
    [within 1 min]
  ) > 5 from seen_at (X
```

### Automated Method

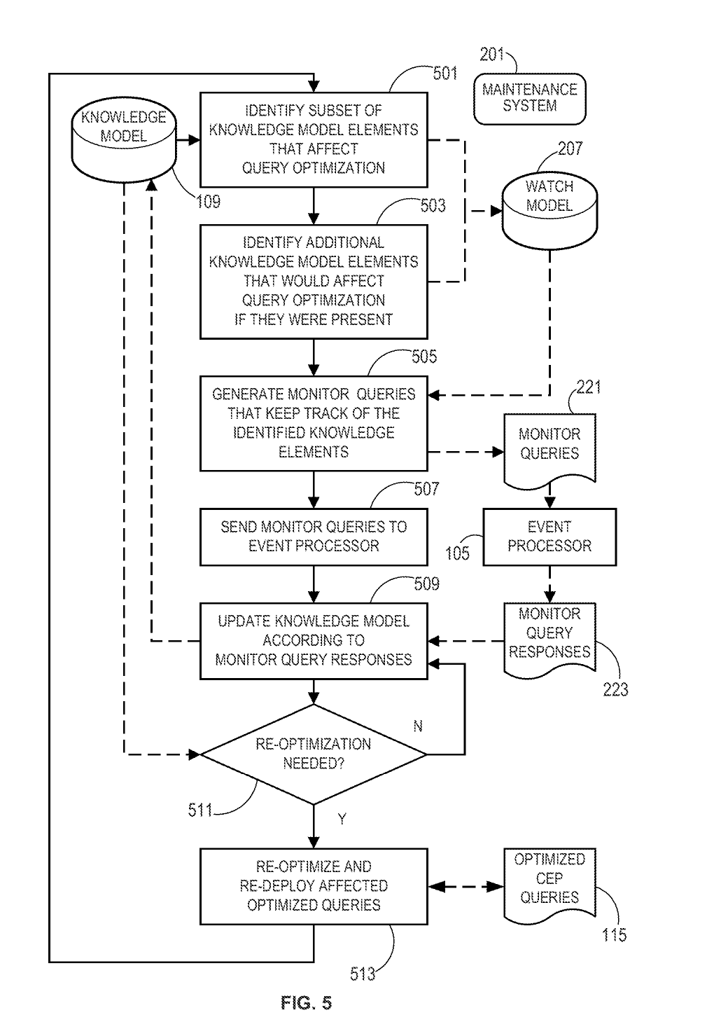

FIG. 5 is a flowchart of an automated method performed by maintenance system 201 for updating a knowledge model 109 and optimized queries 115 according to an embodiment of the present invention. Components shown in FIG. 2 participate in this embodiment, as indicated in FIG. 5. In a step 501 a subset of knowledge model elements that affect query optimization is identified, and these elements are used to build watch model 207. In a related embodiment, a step 503 identifies additional knowledge elements that would affect query optimization if they were present in knowledge base 109, and these elements are also used in watch model 207. In a step 505 monitor queries 221 are generated to keep track of the identified knowledge, elements in watch model 207, and in a step 507 monitor queries 221 are sent to the event processor (event processor 105 in FIG. 1 and FIG. 2). In a step 509, knowledge model 109 is updated according to monitor query responses 223. At a decision point 511, it is determined whether query re-optimization is needed, and if so, in a step 513 optimized CEP queries 115 are re-optimized and re-deployed in accordance with updated knowledge model 109. The method repeats, continually updating knowledge model 109 according to monitor query responses 223 at step 509, and continually identifying knowledge model elements that affect optimization at step 501.

### Complex Event Processing System Maintenance Product

An embodiment of the present invention provides a maintenance product for updating a complex event processing system in response to external real-world changes. The maintenance product includes executable code stored within a machine-readable non-transitory data storage, such that when the executable code is executed by a data processing device, the executable code causes the data processing device to perform a method of the present invention as disclosed herein, including the method illustrated in FIG. 5 and described previously.

What is claimed is:

1. A maintenance system for updating an event processing system in response to real-world changes, wherein the complex event processing system includes an event processor, a query optimizer, and a knowledge model for which there exists at least one original query and at least one optimized query related thereto, the maintenance system comprising:
a data processing system, including:
an optimization analyzer, for analyzing the at least one optimized query against the at least one original query, and identifying a subset of the knowledge model that affects query optimization;
a watch model stored in a non-transitory data storage unit of the data processing system, wherein the watch model includes the subset of the knowledge model that affects query optimization;
a monitor query generator, for generating a monitor query based on the subset of the knowledge model that affects query optimization, and for sending the monitor query to the event processor; and
a knowledge change listener, for receiving a monitor query response from the event processor in response to the monitor query, for updating the knowledge model according to the monitor query response, and, if re-optimization is required, for sending an initiate optimization command to the query optimizer.

2. The maintenance system of claim 1, wherein the optimization analyzer is included in the query optimizer, and wherein the watch model is determined by the query optimizer.

3. The maintenance system of claim 1, wherein the knowledge model comprises a relationship selected from a group consisting of: a temporal relation; and an order relation.

4. The maintenance system of claim 1, wherein the optimization analyzer is further operative to identify an additional knowledge model element that would affect query optimization if present in the knowledge model, wherein the watch model includes the additional knowledge model element, and wherein the monitor query generator is operative to generate a monitor query based on the additional knowledge model element.

5. The maintenance system of claim 1, wherein the knowledge model is at least partly based on a behavioral profile.

6. The maintenance system of claim 1, wherein the watch model includes at least one rule.

7. A method for updating an event processing system in response to real-world changes, wherein the complex event processing system includes an event processor, a query optimizer, and a knowledge model for which there exists at least one optimized query, the method comprising:
identifying a subset of the knowledge model that affects query optimization;
generating a monitor query to keep track of the identified subset of the knowledge model;
sending the monitor query to the event processor;
updating the knowledge model according to a query response from the event processor; and
re-optimizing an affected optimized query in accordance with the updated knowledge model.

8. The method of claim 7, further comprising:
including in the identified subset of the knowledge model an additional knowledge model element that would affect query optimization if present in the knowledge model.

9. The method of claim 7, wherein the knowledge model is at least partly based on a behavioral profile.

10. The method of claim 7, wherein the subset of the knowledge model is stored in a watch model.

11. The method of claim 10, wherein the watch model includes at least one rule.

12. A maintenance product for updating an event processing system in response to real-world changes, wherein the complex event processing system includes an event processor, a query optimizer, and a knowledge model for which there exists at least one optimized query, the maintenance product comprising executable code stored in a machine-readable non-transitory data storage, such that when the executable code is executed by a data processing device, the executable code causes the data processing device to perform:
identifying a subset of the knowledge model that affects query optimization;
generating a monitor query to keep track of the identified subset of the knowledge model;
sending the monitor query to the event processor;
updating the knowledge model according to a query response from the event processor; and
re-optimizing an affected optimized query in accordance with the updated knowledge model.

13. The maintenance product of claim 12, wherein the executable code causes the data processing device to further perform:
including in the identified subset of the knowledge model an additional knowledge model element that would affect query optimization if present in the knowledge model.

14. The maintenance product of claim 12, wherein the knowledge model is at least partly based on a behavioral profile.

15. The maintenance product of claim 12, wherein the subset of the knowledge model is stored in a watch model.

16. The maintenance product of claim 15, wherein the watch model includes at least one rule.
